(19) United States
(12) Patent Application Publication
(10) Pub. No.: US 2009/0121966 A1
(43) Pub. Date: May 14, 2009

(54) MULTIMODE ANTENNA

(75) Inventors: Jia-Jiu Song, Taipei County (TW); Mu-Kun Hsueh, Kaohsiung City (TW)

Correspondence Address: APEX JURIS, PLLC, 12733 LAKE CITY WAY NORTHEAST, SEATTLE, WA, 98125, US

(73) Assignee: SmartAnt Telecom Co., Ltd., Hsinchu County (TW)

(21) Appl. No.: 11/939,759

(22) Filed: Nov. 14, 2007

(51) Int. Cl. H01Q 9/04; H01Q 21/00

(52) U.S. Cl. 343/893; 343/700 MS

(57) ABSTRACT

A multimode antenna that integrates antennae of at least three modes includes antenna radiation elements of at least three modes and a common ground element. In conventional wireless communication devices, in order to achieve the multiplexing effect, a plurality of antennae is built therein, which cannot meet the requirements for both multiplexing and small size. The multimode antenna integrates antennae of a plurality of modes together and shares one ground element, which not only reduces the volume of the antenna, but also achieves a multimode antenna for a multiplex device.

### BACKGROUND OF THE INVENTION

1. Field of Invention

The present invention relates to a multimode antenna, and more particularly to a multimode antenna of multiplex device.

2. Related Art

As for wireless communication devices, an antenna is a bridge for communicating with the outside world. The design of antenna has been gradually switched from the configuration of being exposed outside into the configuration of being hidden inside. As the wireless communication device has increasingly powerful functions, from the simple function of making a call to the function of audio-visual entertainments, the design of antenna is required to have the features of high performance, low radiation, small size, and easy matching.

Currently, the wireless communication device requiring an antenna includes notebook, mobile phone, mobile TV, and satellite navigation system, and so on, in which a successful antenna design is required to achieve the optimal performance. Currently, more and more integrated products have been developed, one wireless communication device may integrate the wireless communication functions, such as Third Generation (3G) mobile communication technology, Wireless Local Area Network (WLAN), and Bluetooth. Each wireless communication system requires a corresponding antenna to transceive signals, and thus, generally, a plurality of antennae may be built in one wireless communication device.

The functions of wireless communication devices are getting more and more complex, and the sizes are required to get smaller and smaller, but the development of chip manufacturing process has its limitations, so under the condition that the miniaturization of silicon chip has reached the limit, the antenna mechanism is further required to become smaller, so as to be beneficial for the miniaturization of the overall configuration.

Therefore, it has become an urgent problem to be solved by researches to provide a communication device having a balanced feature in both function and volume, i.e., having an antenna design of smaller volume and even having an antenna integration suitable for different applications.

### SUMMARY OF THE INVENTION

In view of the above problems, the present invention is directed to a multimode antenna, which integrates antennae of a plurality of modes together and shares one ground element, and thus not only the volume of the antenna is reduced, but the antenna may also be integrated with a current wireless communication device, thereby achieving a portable and miniaturized multimode wireless communication device.

The multimode antenna according to the present invention integrates antennae of at least three modes and includes antenna radiation elements of at least three modes and a common ground element. The antenna radiation elements of at least three modes are used to transmit and receive electromagnetic signals of at least three modes. The antenna radiation elements may be, but not limited to, Wireless Local Area Network/Worldwide Interoperability for Microwave Access (WLAN/WiMax) antenna radiation element, ultra wideband (UWB) antenna radiation element, and/or wireless local area network (WLAN) antenna radiation element. The common ground element connects the antenna radiation elements of at least three modes. The common ground element is a plate-shaped ground element and conducts the current of the antenna radiation elements to the ground. The wireless communication device may be a notebook, a PDA, and definitely may be other wireless communication devices.

The multimode antenna receives the signal current fed in to the multimode antenna through the signal feed-in portion and transfers the signal current to an antenna radiation element corresponding to the mode. The antenna radiation element is used to transmit and receive an electromagnetic signal corresponding to the mode. Due to the design of the multimode antenna, antennae of a plurality of mode are integrated together and share one ground element, so that not only the volume of the antenna is reduced, but the multimode antenna may also be integrated with the current wireless communication device, and thus achieving a space-saving and miniaturized multimode antenna for a multiplex device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic structural view of a first embodiment of the present invention;

FIG. 2 is a schematic structural view of a second embodiment of the present invention; and

FIG. 3 is a schematic structural view of a third embodiment of the present invention.

### DETAILED DESCRIPTION OF THE INVENTION

The features and practice of the present invention are illustrated below in detail with reference to the accompanying drawings.

The multimode antenna according to an embodiment of the present invention includes antenna radiation elements of at least three modes. The antenna radiation elements may be, but not limited to, Wireless Local Area Network/Worldwide Interoperability for Microwave Access (WLAN/WiMax) antenna radiation element, ultra wideband (UWB) antenna radiation element, and wireless local area network (WLAN) antenna radiation element.

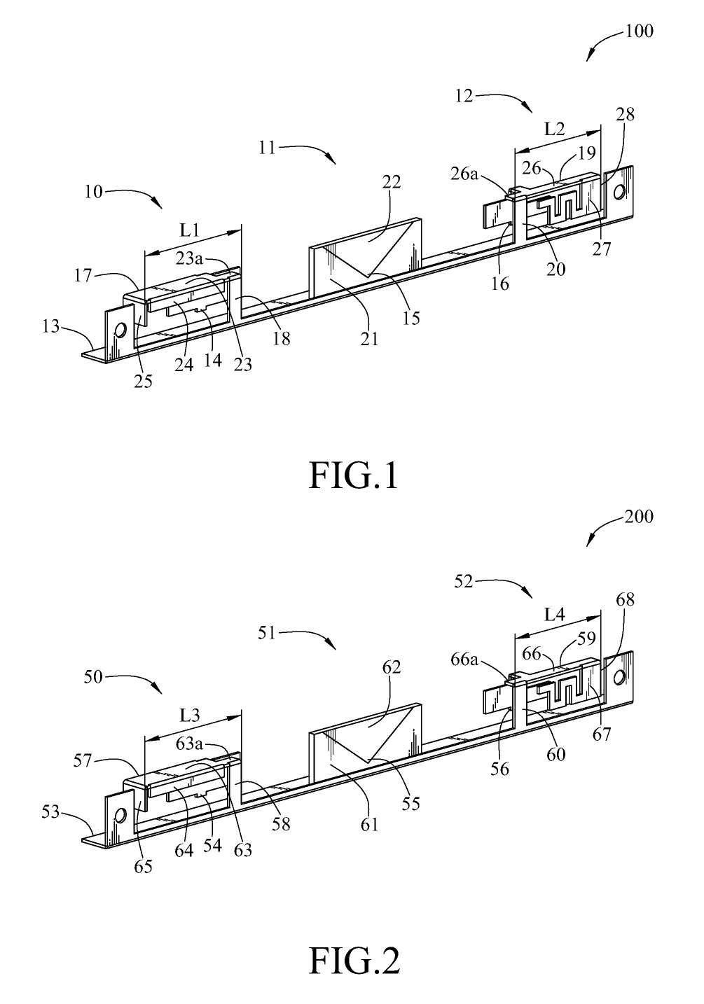

Referring to FIG. 1, it is a schematic structural view of a first embodiment of the present invention. A multimode antenna 100 includes a WLAN/WiMax antenna radiation element 10, a UWB antenna radiation element 11, a WLAN antenna radiation element 12, and a common ground element 13.

The WLAN/WiMax antenna radiation element 10 is an inverted F-shaped antenna and includes: a radiation element 17, a conductive pin 18, and a signal feed-in portion 14. The material of the WLAN/WiMax antenna radiation element 10 may be, but not limited to, copper, aluminum, and silver.

The radiation element 17 is a strip-shaped radiator for transmitting and receiving electromagnetic signals with a resonance frequency f₁ (2.4 GHz-2.7 GHz). The radiation element 17 includes: a strip-shaped metal sheet 23, a first metal sheet 24, and a second metal sheet 25. The side edge of the first metal sheet 24 is perpendicularly connected to one major axis side edge of the strip-shaped metal sheet 23. The first metal sheet 24 has a geometric shape, such as square and rectangle. The side edge of the second metal sheet 25 is perpendicular to one minor axis side edge of the strip-shaped metal sheet 23. The second metal sheet 25 has a geometric shape, such as square and rectangle. The length L₁ of the radiation element 17 is determined depending upon the wavelength λ₁ of the resonance frequency f₁ (f₁=c/λ₁). The length L₁ of the radiation element 17 is approximately equal to a quarter of the wavelength λ₁ of the resonance frequency f₁.

The conductive pin 18 is located between the radiation element 17 and the common ground element 13. One end of the conductive pin 18 is connected to a major axis side end 23a of the strip-shaped metal sheet 23 at the same side as the first metal sheet 24, and the other side of the conductive pin 18 extends and is connected on the common ground element 13.

The signal feed-in portion 14 is perpendicularly connected to the other major axis side edge of the strip-shaped metal sheet 23, for feeding in a signal current to the radiation element 17 or receiving a signal current fed out from the radiation element 17.

The WLAN antenna radiation element 12 is an inverted F-shaped antenna and includes: a radiation element 19, a conductive pin 20, and a signal feed-in portion 16. The material of the WLAN antenna radiation element 12 may be, but not limited to, copper, aluminum, and silver.

The radiation element 19 is a strip-shaped radiator, for transmitting and receiving an electromagnetic signal with a resonance frequency f₂ (2.4 GHz-2.5 GHz). The radiation element 19 includes: a strip-shaped metal sheet 26, a zigzagged metal sheet 27, and a metal sheet 28. The zigzagged metal sheet 27 is perpendicularly connected to one major axis side edge of the strip-shaped metal sheet 26. The side edge of the metal sheet 28 is perpendicular to the minor axis side edge of the strip-shaped metal sheet 26. The metal sheet 28 has a geometric shape, such as square and rectangle. The length L₂ of the radiation element 19 is determined depending upon the wavelength λ₂ of the resonance frequency f₂ (f₂=c/λ₂). The length L₂ of the radiation element 19 is approximately equal to a quarter of the wavelength λ₂ of the resonance frequency f₂.

The conductive pin 20 is located between the radiation element 19 and the common ground element 13. One end of the conductive pin 20 is connected to a major axis side end 26a of the strip-shaped metal sheet 26 at the same side as the first metal sheet 27, and the other end of the conductive pin 20 extends and is connected on the common ground element 13.

The signal feed-in portion 16 is perpendicularly connected to the other major axis side edge of the strip-shaped metal sheet 26, for feeding in a signal current to the radiation element 19 or receiving a signal current fed out from the radiation element 19.

The UWB antenna radiation element 11 includes: an insulating substrate 21, a radiation element 22, and a signal feed-in portion 15. The insulating substrate 21 is connected on the common ground element 13. The radiation element 22 is connected on one side of the insulating substrate 21, to serve as a radiator. The radiation element 22 may be, but not limited to, a metal body and a metal layer. The radiation element 22 may have a semicircular shape, a semi-oval shape, or other geometric shapes. The material of the radiation element 22 may be copper, aluminum, and silver or other conductive metals. The UWB antenna radiation element 11 is used to replace a conical antenna used in prior art, and to receive a signal current fed in from the signal feed-in portion 15 and transmit an electromagnetic signal with a resonance frequency (3 GHz-10 GHz), which may further sense an electromagnetic signal at the frequency and output the sensed signal current through the signal feed-in portion 15.

The common ground element 13 is a plate-shaped ground element and is connected to the WLAN/WiMax antenna radiation element 10, the UWB antenna radiation element 11, and the WLAN antenna radiation element 12 through the conductive pin 18, the conductive pin 20, and the insulating substrate 21 respectively. The common ground element 13 conducts the currents of the WLAN/WiMax antenna radiation element 10, the UWB antenna radiation element 11, and the WLAN antenna radiation element 12 to the ground. The material of the common ground element 13 is selected from a group consisting of copper, aluminum, and silver.

When the antenna radiation elements of three different modes on the multimode antenna 100, i.e., the WLAN/WiMax antenna radiation element 10, the UWB antenna radiation element 11, and the WLAN antenna radiation element 12, resonantly receive electromagnetic waves corresponding to the mode thereof, the sensed signal currents may be transferred and sent out through the signal feed-in portions connected to the antenna radiation elements. Similarly, the antenna radiation elements of three different modes may also receive signal currents with the resonance frequencies corresponding to the modes thereof that are fed in from the signal feed-in portion and resonantly send out an electromagnetic wave with the resonance frequency. The multimode antenna 100 integrates antennae of three different modes by the antenna radiation elements of three different modes that share one ground element, thus achieving a function of a space-saving and miniaturized multimode wireless communication device.

Referring to FIG. 2, it is a schematic structural view of a second embodiment of the present invention. A multimode antenna 200 includes a first WLAN antenna radiation element 50, a UWB antenna radiation element 51, a second WLAN antenna radiation element 52, and a common ground element 53.

The first WLAN antenna radiation element 50 is an inverted F-shaped antenna and includes: a radiation element 57, a conductive pin 58, and a signal feed-in portion 54. The material of the first WLAN antenna radiation element 50 may be, but not limited to, copper, aluminum, and silver.

The radiation element 57 is a strip-shaped radiator, for resonantly transceiving an electromagnetic signal with a resonance frequency f₃ (2.4 GHz-2.5 GHz). The radiation element 57 includes: a strip-shaped metal sheet 63, a first metal sheet 64, and a second metal sheet 65. The side edge of the first metal sheet 64 is perpendicularly connected to one major axis side edge of the strip-shaped metal sheet 63. The first metal sheet 64 has a geometric shape, such as square and rectangle. The side edge of the second metal sheet 65 is perpendicular to one minor axis side edge of the strip-shaped metal sheet 63. The second metal sheet 65 has a geometric shape, such as square and rectangle. The length L₃ of the radiation element 57 is determined depending upon the wavelength λ₃ of the resonance frequency f₃ (f₃=c/λ₃). The length L₃ of the radiation element 57 is approximately equal to a quarter of the wavelength λ₃ of the resonance frequency f₃.

The conductive pin 58 is located between the radiation element 57 and the common ground element 53. One end of the conductive pin 58 is connected to a major axis side end 63a of the strip-shaped metal sheet 63 at the same side as the first metal sheet 64, and the other end of the conductive pin 58 extends and is connected on the common ground element 53.

The signal feed-in portion 54 is perpendicularly connected on the other major axis side edge of the strip-shaped metal sheet 63, for feeding in a signal current to the radiation element 57 or receiving a signal current fed out from the radiation element 57.

The second WLAN antenna radiation element 52 is an inverted F-shaped antenna and includes: a radiation element 59, a conductive pin 60, and a signal feed-in portion 56. The material of the second WLAN antenna radiation element 52 may be, but not limited to, copper, aluminum, and silver.

The radiation element 59 is a strip-shaped radiator, for resonantly transceiving an electromagnetic signal with the resonance frequency f₄ (2.4 GHz-2.5 GHz). The radiation element 59 includes: a strip-shaped metal sheet 66, a zigzagged metal sheet 67, and a metal sheet 68. The zigzagged metal sheet 67 is perpendicularly connected to one major axis side edge of the strip-shaped metal sheet 66. The side edge of the metal sheet 68 is perpendicular to one minor axis side edge of the strip-shaped metal sheet 66. The metal sheet 68 has a geometric shape, such as square and rectangle. The length L₄ of the radiation element 59 is determined depending upon the wavelength λ₄ of the resonance frequency f₄ (f₄=c/λ₄). The length L₄ of the radiation element 59 is approximately equal to a quarter of the wavelength λ₄ of the resonance frequency f₄.

The conductive pin 60 is located between the radiation element 59 and the common ground element 53. One end of the conductive pin 60 is connected to a major axis side end 66a of the strip-shaped metal sheet 66 at the same side as the zigzagged metal sheet 67, and the other end of the conductive pin 60 extends and is connected on the common ground element 53.

The signal feed-in portion 56 is perpendicularly connected to the other major axis side edge of the strip-shaped metal sheet 66, for feeding in a signal current to the radiation element 59 or receiving a signal current fed out from the radiation element 59.

The UWB antenna radiation element 51 includes: an insulating substrate 61, a radiation element 62, and a signal feed-in portion 55. The insulating substrate 61 is connected on the common ground element 53. The radiation element 62 is connected on one side of the insulating substrate 61, to serve as a radiator. The radiation element 62 may be, but not limited to, a metal body and a metal layer. The radiation element 62 may have a semicircular shape, a semi-oval shape, or other geometric shapes. The material of the radiation element 62 may be copper, aluminum, and silver or other conductive metals. The UWB antenna radiation element 51 is used to replace the conical antenna used in prior art, and to receive a signal current fed in from the signal feed-in portion 55 and transmit an electromagnetic signal with the resonance frequency (3 GHz-10 GHz), which may further sense an electromagnetic signal at the frequency and output the sensed signal current through the signal feed-in portion 55.

The common ground element 53 is a plate-shaped ground element and it is respectively connected to the WLAN/WiMax antenna radiation element 50, the UWB antenna radiation element 51, and the WLAN antenna radiation element 52 through the conductive pin 58, the conductive pin 60, and the insulating substrate 61. The common ground element 53 conducts the currents of the WLAN/WiMax antenna radiation element 50, the UWB antenna radiation element 51, and the WLAN antenna radiation element 52 to the ground. The material of the common ground element 53 is selected from a group consisting of copper, aluminum, and silver.

When the first WLAN antenna radiation element 50 and the second WLAN antenna radiation element 52 on the multimode antenna 200 are antenna radiation elements of the same mode, upon resonantly receiving an electromagnetic wave with the resonance frequency (2.4 GHz-2.5 GHz) corresponding to the mode thereof, the first WLAN antenna radiation element 50 serves as a main antenna, and the second WLAN radiation element 52 serves as an auxiliary antenna, so as to improve the strength of the multimode antenna 200 in resonantly receiving and transmitting the electromagnetic signal at the resonance frequency (2.4 GHz-2.5 GHz). Therefore, the multimode antenna 200 has three-mode antenna radiation elements and is capable of resonantly transceiving electromagnetic waves with the resonance frequencies corresponding to two different modes. Once the electromagnetic wave with the resonance frequency corresponding to the mode thereof is resonantly received, the sensed signal current will be transferred and sent out through the signal feed-in portion connected to the antenna radiation element. Similarly, the antenna radiation elements of three different modes may also receive signal currents with the resonance frequencies corresponding to the modes thereof that are fed in via the signal feed-in portion and resonantly transmit electromagnetic waves with the resonance frequency. The multimode antenna 200 integrates antennae of two different modes together through the antenna radiation elements of three different modes that share one ground element, and thus achieving a function of a space-saving and miniaturized multimode wireless communication device.

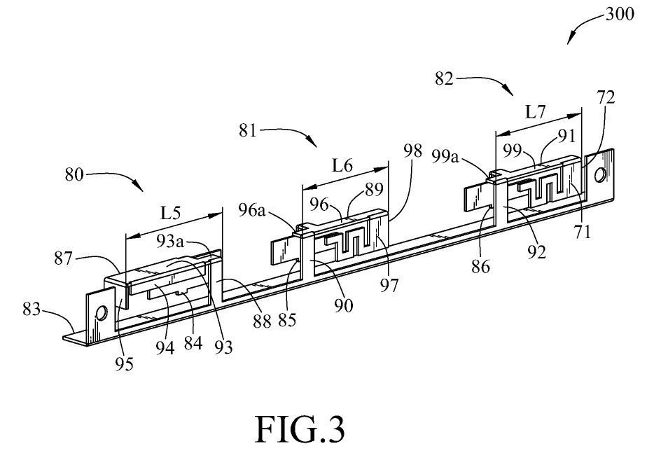

Referring to FIG. 3, it is a schematic structural view of a third embodiment of the present invention. A multimode antenna 300 includes a first WLAN antenna radiation element 80, a second WLAN antenna radiation element 81, a third WLAN antenna radiation element 82, and a common ground element 83.

The first WLAN antenna radiation element 80 is an inverted F-shaped antenna and includes: a radiation element 87, a conductive pin 88, and a signal feed-in portion 84. The material of the first WLAN antenna radiation element 80 may be, but not limited to, copper, aluminum, and silver.

The radiation element 87 is a strip-shaped radiator, for resonantly transceiving an electromagnetic signal with the resonance frequency f₅ (2.4 GHz-2.5 GHz). The radiation element 87 includes: a strip-shaped metal sheet 93, a first metal sheet 94, and a second metal sheet 95. The side edge of the first metal sheet 94 is perpendicularly connected to one major axis side edge of the strip-shaped metal sheet 93. The first metal sheet 94 has a geometric shape, such as square and rectangle. The side edge of the second metal sheet 95 is perpendicular to one minor axis side edge of the strip-shaped metal sheet 93. The second metal sheet 95 has a geometric shape, such as square and rectangle. The length L₅ of the radiation element 87 is determined depending upon the wavelength λ₅ of the resonance frequency f₅ (f₅=c/λ₅). The length L₅ of the radiation element 87 is approximately equal to a quarter of the wavelength λ₅ of the resonance frequency f₅.

The conductive pin 88 is located between the radiation element 87 and the common ground element 83. One end of the conductive pin 88 is connected on a major axis side end 93a of the strip-shaped metal sheet 93 at the same side as the first metal sheet 94, and the other end of the conductive pin 88 extends and is connected on the common ground element 83.

The signal feed-in portion 84 is perpendicularly connected to the other major axis side edge of the strip-shaped metal sheet 93, for feeding in a signal current to the radiation element 87 or receiving a signal current fed out from the radiation element 87.

The second WLAN antenna radiation element 81 is an inverted F-shaped antenna and includes: a radiation element 89, a conductive pin 90, and a signal feed-in portion 85. The material of the second WLAN antenna radiation element 81 may be, but not limited to, copper, aluminum, and silver.

The radiation element 89 is a strip-shaped radiator, for resonantly transceiving an electromagnetic signal with the resonance frequency f₆ (2.4 GHz-2.5 GHz). The radiation element 89 includes: a strip-shaped metal sheet 96, a zigzagged metal sheet 97, and a metal sheet 98. The zigzagged metal sheet 97 is perpendicularly connected to one major axis side edge of the strip-shaped metal sheet 96. One side edge of the metal sheet 98 is perpendicular to one minor axis side edge of the strip-shaped metal sheet 96. The metal sheet 98 has a geometric shape, such as square and rectangle. The length L₆ of the radiation element 89 is determined depending upon the wavelength λ₆ of the resonance frequency f₆ (f₆=c/λ₆). The length L₆ of the radiation element 89 is approximately equal to a quarter of the wavelength λ₆ of the resonance frequency f₆.

The conductive pin 90 is located between the radiation element 89 and the common ground element 83. One end of the conductive pin 90 is connected on a major axis side end 96a of the strip-shaped metal sheet 96 at the same side as the zigzagged metal sheet 97, and the other end of the conductive pin 90 extends and is connected on the common ground element 83.

The signal feed-in portion 85 is perpendicularly connected to the other major axis side edge of the strip-shaped metal sheet 96, for feeding in a signal current to the radiation element 89 or receiving a signal current fed out from the radiation element 89.

The third WLAN antenna radiation element 82 is an inverted F-shaped antenna and includes: a radiation element 91, a conductive pin 92, and a signal feed-in portion 86. The material of the third WLAN antenna radiation element 82 may be, but not limited to, copper, aluminum, and silver.

The radiation element 91 is a strip-shaped radiator, for resonantly transceiving an electromagnetic signal with the resonance frequency f₇ (2.4 GHz-2.5 GHz). The radiation element 91 includes: a strip-shaped metal sheet 99, a zigzagged metal sheet 71, and a metal sheet 72. The zigzagged metal sheet 71 is perpendicularly connected to one major axis side edge of the strip-shaped metal sheet 99. The side edge of the metal sheet 72 is perpendicular to one minor axis side edge of the strip-shaped metal sheet 99. The metal sheet 72 has a geometric shape, such as square and rectangle. The length L₇ of the radiation element 91 is determined depending upon the wavelength λ₇ the of the resonance frequency f₇ (f₇=c/λ₇). The length L₇ of the radiation element 91 is approximately equal to a quarter of the wavelength λ₇ of the resonance frequency f₇.

The conductive pin 92 is located between the radiation element 91 and the common ground element 83. One end of the conductive pin 92 is connected on a major axis side end 99a of the strip-shaped metal sheet 99 at the same side as the zigzagged metal sheet 71, and the other end of the conductive pin 92 extends and is connected on the common ground element 83.

The signal feed-in portion 86 is perpendicularly connected to the other major axis side edge of the strip-shaped metal sheet 99, for feeding in a signal current to the radiation element 91 or receiving a signal current fed out from the radiation element 91.

When the antenna radiation elements of three modes on the multimode antenna 300, i.e., the first WLAN antenna radiation element 80, the second WLAN antenna radiation element 81, and the third WLAN antenna radiation element 82 are the antenna radiation elements of the same mode, upon resonantly receiving an electromagnetic wave with the resonance frequency (2.4 GHz-2.5 GHz) corresponding to the mode thereof, the multimode antenna 300 is used as a multiplex device of multiple input multiple output (MIMO). That is, without occupying additional radio frequencies, multiple paths are used to provide higher data throughput and thus increasing the coverage area and the reliability. That is, within the same time, two or more data signals may be transferred in the same radio resonance frequency (2.4 GHz-2.5 GHz).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multimode antenna, integrating antennae of at least three modes, comprising:
antenna radiation elements of at least three modes, for receiving and transmitting electromagnetic signals of more than three modes; and
a common ground element, connected to the antenna radiation elements, for conducting a current of the antenna radiation elements to the ground.

2. The multimode antenna as claimed in claim 1, wherein the antenna radiation elements of at least three modes are a Wireless Local Area Network/Worldwide Interoperability for Microwave Access (WLAN/WiMax) antenna radiation element, an ultra wideband (UWB) antenna radiation element, and a WLAN antenna radiation element.

3. The multimode antenna as claimed in claim 1, wherein the antenna radiation elements of at least three modes comprise a first WLAN antenna radiation element, a UWB antenna radiation element, and a second WLAN antenna radiation element.

4. The multimode antenna as claimed in claim 1, wherein the antenna radiation elements of at least three modes comprise a first WLAN antenna radiation element, a second WLAN antenna radiation element, and a third WLAN antenna radiation element.

5. The multimode antenna as claimed in claim 2, wherein the WLAN antenna radiation element is an inverted F-shaped antenna, and comprises: a radiation element, serving as a radiator; a conductive pin, for connecting the radiation element and the common ground element; and a signal feed-in portion, connected to the radiation element, for feeding in a signal current to the radiation element and receiving a signal current fed in from the radiation element.

6. The multimode antenna as claimed in claim 2, wherein the UWB antenna radiation element comprises: an insulating substrate, fixed at the common ground element; a radiation element, connected on the insulating substrate, for receiving and transmitting a radio signal; and a signal feed-in portion, connected to the radiation element, for feeding in a signal current to the radiation element and receiving a signal current fed in from the radiation element.

7. The multimode antenna as claimed in claim 6, wherein the radiation element is selected from a group consisting of a metal body and a metal layer.

8. The multimode antenna as claimed in claim 2, wherein the WLAN/WiMax antenna radiation element is an inverted F-shaped antenna, and comprises: a radiation element, serving as a radiator; a conductive pin, for connecting the radiation element and the common ground element; and a signal feed-in portion, connected to the radiation element, for feeding in a signal current to the radiation element and receiving a signal current fed in from the radiation element.

9. The multimode antenna as claimed in claim 3, wherein the first WLAN antenna radiation element is an inverted F-shaped antenna, and comprises: a radiation element, serving as a radiator; a conductive pin, for connecting the radiation element and the common ground element; and a signal feed-in portion, connected to the radiation element, for feeding in a signal current to the radiation element and receiving a signal current fed in from the radiation element.

10. The multimode antenna as claimed in claim 3, wherein the UWB antenna radiation element comprises: an insulating substrate, fixed at the common ground element; a radiation element, connected on the insulating substrate, for receiving and transmitting a radio signal; and a signal feed-in portion, connected to the radiation element, for feeding in a signal current to the radiation element and receiving a signal current fed in from the radiation element.

11. The multimode antenna as claimed in claim 10, wherein the radiation element is selected from a group consisting of a metal body and a metal layer.

12. The multimode antenna as claimed in claim 3, wherein the second WLAN antenna radiation element is an inverted F-shaped antenna, and comprises: a radiation element, serving as a radiator; a conductive pin, for connecting the radiation element and the common ground element; and a signal feed-in portion, connected to the radiation element, for feeding in a signal current to the radiation element and receiving a signal current fed in from the radiation element.

13. The multimode antenna as claimed in claim 4, wherein the first WLAN antenna radiation element is an inverted F-shaped antenna, and comprises: a radiation element, serving as a radiator, a conductive pin, for connecting the radiation element and the common ground element; and a signal feed-in portion, connected to the radiation element, for feeding in a signal current to the radiation element and receiving a signal current fed in from the radiation element.

14. The multimode antenna as claimed in claim 4, wherein the second WLAN antenna radiation element is an inverted F-shaped antenna, and comprises: a radiation element, serving as a radiator; a conductive pin, for connecting the radiation element and the common ground element; and a signal feed-in portion, connected to the radiation element, for feeding in a signal current to the radiation element and receiving a signal current fed in from the radiation element.

15. The multimode antenna as claimed in claim 4, wherein the third WLAN antenna radiation element is an inverted F-shaped antenna, and comprises: a radiation element, serving as a radiator; a conductive pin, for connecting the radiation element and the common ground element; and a signal feed-in portion, connected to the radiation element, for feeding in a signal current to the radiation element and receiving a signal current fed in from the radiation element.
